(19) United States
(12) Patent Application Publication
(10) Pub. No.: US 2019/0183290 A1
(43) Pub. Date: Jun. 20, 2019

(54) Soup Oil Strainer & Trapper

(71) Applicant: Solomon Juravel, Airmont, NY (US)

(72) Inventor: Solomon Juravel, Airmont, NY (US)

(21) Appl. No.: 15/844,568

(22) Filed: Dec. 17, 2017

(51) Int. Cl. A47J 43/28

(52) U.S. Cl. CPC A47J 43/284

(57) ABSTRACT

This disclosure relates generally to oil strainer with holes that open and close with a flick of a switch. In an instant, the oil strainer transforms to a solid floor, allowing the user to entrap the unwanted hot oil and create a crisp soup, broth, or stew. A strainer with small holes sits just below the transforming solid floor, to slightly press down soup contents; preventing soup contents from being cut or going in the oil trapper.

### BACKGROUND

### Field of the Invention

This invention relates to kitchen utensils, specifically to such utensils which relates to oil strainer with holes that open and close with a flick of a switch.

Aspects of the present invention relate more particularly to a solid floor, allowing the user to entrap the unwanted hot oil and create a crisp soup, broth, or stew. A strainer with small holes sits just below the transforming solid floor, to slightly press down the soup contents; preventing the soup contents from being cut or going in the oil trapper. The purpose of this kind of oil strainer and trapper is to remove the excess fat or oil from the top of soup, or other kind of liquid—and maintain the integrity of the soup contents (e.g., veggies, poultry, meat, etc.).

### Description of the Related Art

The application is related to cooking and other activities where the removal of liquid fat or liquid oil has to be accomplished. Removal of excess fat or oil from the soup or stew would help to create healthier food for children and adults.

U.S. Pat. No. 858,291 to Irby (1907) shows a device with complicated construction, a cumbersome handle and with the hole in the center of the concentrating cone being proportionally too large for effective concentration of the fat. This device has no pour spout for emptying. One alternative embodiment presented has an insufficient angle on the concentrating cone to function properly, and the edge of the cup is much too high. The alternative embodiments concentrate the fat very little prior to removal. None of the embodiments presented have a screen positioned to prevent floating material from clogging the device.

U.S. Pat. No. 2,575,768 to Pearsall (1951) shows a skimmer with excessively complicated and difficult construction and operation, with the handle on this device shaped such that the device cannot be lowered into a deep pot. This device has a very shallow angle on the concentrating cone and the top of the cone terminates in a vertical cylinder which serves no constructive purpose and causes the device to require a deeper broth in which to function. This device has corners and crevices which are impossible to clean, and the operator cannot see when the device is full. This device has no provision for a screen to prevent clogging.

U.S. Pat. No. Des. 210,399 to Wichmann (1968) shows a device with a very shallow angle on the concentrating cone which makes this device slow and inefficient. The sides of this device are much higher than necessary to collect the fat that is separated and the very short handle on this device makes it dangerous to use around boiling liquids. The device has a crevice around the base of the wall which is inaccessible to cleaning and it has no provision for a screen to separate particulate matter.

U.S. Pat. No. 5,084,177 to Keene (1992) shows a device with a very shallow collecting dome which has various small domes protruding upward from the large dome with each of these small domes having a small hole in its apex. This device is very inefficient due to the very shallow angle of the collecting dome. It has no screen and so the small holes will plug almost immediately upon use in any broth with even the smallest pieces of floating particulate matter.

However, to the Applicant's knowledge, none of these prior art methods have been found to be completely suitable to meet these needs and are cumbersome and non-durable. Hence, the inventor of the present invention proposes to resolve and surmount existent technical difficulties and to eliminate the aforementioned shortcomings of prior art. Therefore, the object of the fat separating device of the present invention is to fill the long-standing need for a fat or liquid separator that is easy to use, efficient, fast, economical, durable, safe, easy to clean and universally useful.

### SUMMARY

In light of the disadvantages of prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

According to a first embodiment, the invention is a hand-held device that open and close with a flick of a switch. In an instant, the oil strainer & trapper transforms to a solid floor, allowing the user to entrap the unwanted hot oil and create a crisp soup, broth, or stew.

Another object of the invention is a strainer that has small holes and sits just below the transforming solid floor, to slightly press down the soup contents; preventing the contents from being cut or going into the oil trapper.

Another object of the invention relates to the oil strainer & trapper that has a clear roof that is completely closed. This contains the oil in the case that it is tipped over. The oil strainer & trapper has the ability to go below its own surface to capture the oil, in which case, there is a lip to hold the oil. Therefore, it can be seen that the right combination of features incorporated in the device of the present invention produces surprising results that are not produced by the prior art.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows the top perspective view of the closure.

FIG. 2 shows the side view of preferred invention.

FIG. 3 shows the holes that are visible.

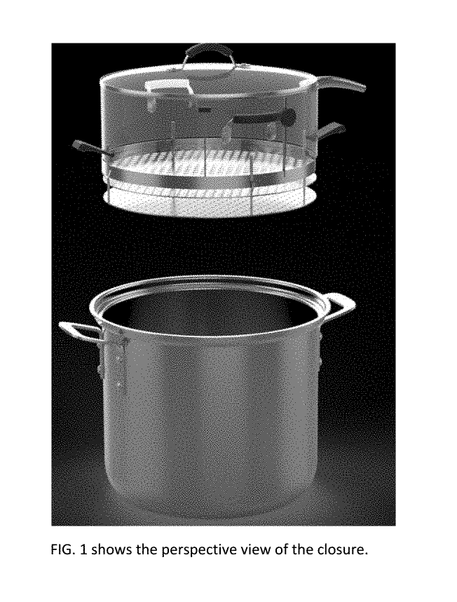

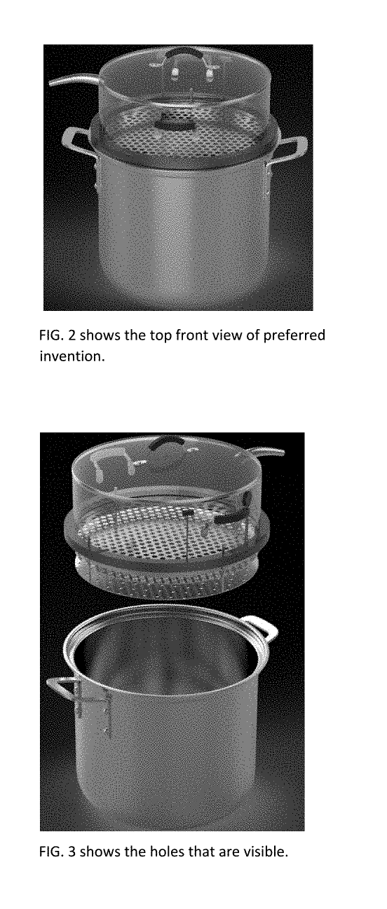

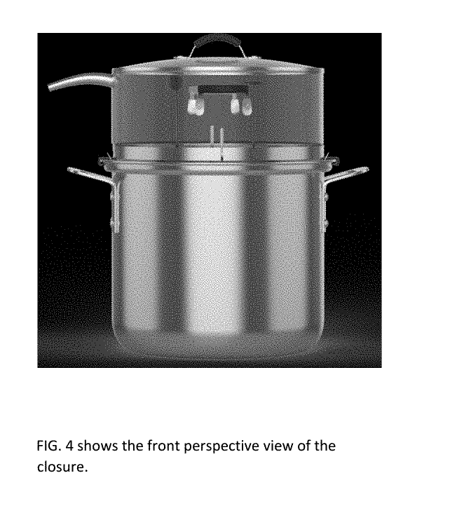

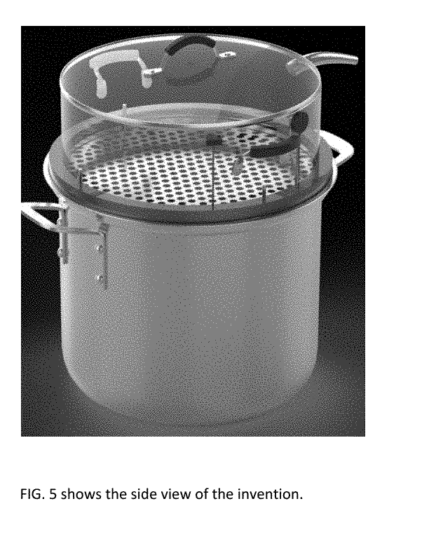

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The oil strainer & trapper transforms to a solid floor, allowing the user to entrap the unwanted hot oil and create a crisp soup, broth, or stew. The oil strainer has a clear glass cover/roof that is completely closed, which can be either removable or non-removable. A strainer with small holes sits just below the transforming solid floor, to slightly press down soup contents; preventing soup contents from being cut or going in the oil trapper. This strainer contains the oil that it is tipped over. The oil strainer has the ability to go below its own surface to capture the oil, in which case, there is a lip to hold the oil.

It is to be understood that the oil strainer has holes that open and close at the flick of a switch. The holes can open to go up and down, as well as, from side to side. The oil strainer also has a spout to drain the oil.

The bottom of the soup oil strainer can easily fit to the soup pot in any of the following two ways: 1) there is a lip that extends from the bottom of the strainer to be placed over the pot, or 2) there is a clip, that comes up (or down) from both sides of the strainer/trapper that allow it to sit on the lip of the soup pot.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1) Oil strainer with holes that open and close, going up and down or side-to-side, with a flick of a switch.
A solid floor, allowing the user to entrap the unwanted hot oil;
A strainer with small holes sits just below the transforming solid floor, to slightly press down soup contents; preventing soup contents from being cut or going in the oil trapper;
Strainer with the ability to go below its own surface to capture the oil, when there is a lip.

2) Removable oil strainer can be taken apart for cleaning purposes.
Oil strainer with a fitted spout to drain the oil;
Another object of the invention relates to the walls of the soup oil strainer and trapper, which is made of glass or stainless steel for clear and easy view;
The oil strainer has a clear glass cover/roof that is completely closed; it can be both removable and non-removable.
